(19) United States
(12) Patent Application Publication
(10) Pub. No.: US 2011/0158854 A1
(43) Pub. Date: Jun. 30, 2011

(54) HYDROGEN CONCENTRATION MEASURING INSTRUMENT

(75) Inventors: Yutaka YAMAGISHI, Kyoto (JP); Shigeru OKUDA, Kyoto (JP); Shuji TAKAMATSU, Kyoto (JP); Kazutaka OKAMOTO, Kyoto (JP); Yoshiaki NAKATA, Kyoto (JP)

(73) Assignee: HORIBA, LTD., Kyoto (JP)

(21) Appl. No.: 12/973,089

(22) Filed: Dec. 20, 2010

(30) Foreign Application Priority Data
Dec. 24, 2009 (JP) 2009-293534
Dec. 25, 2009 (JP) 2009-294276

(51) Int. Cl. G01N 31/10

(52) U.S. Cl. 422/83

(57) ABSTRACT

This invention is to obtain a highly reliable measurement result by correcting a hydrogen concentration by the use of a concentration of oxygen contained in a measurement gas, and the hydrogen concentration measuring instrument comprises a hydrogen concentration measuring part 2 that measures the concentration of hydrogen contained in the measurement gas flowing in a flow channel, an oxygen concentration measuring unit 3 that measures a concentration of oxygen contained in the measurement gas, and a concentration correcting unit 73 that corrects the concentration of hydrogen obtained by the hydrogen concentration measuring part 2 by the use of the concentration of oxygen obtained by the oxygen concentration measuring unit 3.

### FIELD OF THE ART

This invention relates to a hydrogen concentration measuring instrument that measures a concentration of hydrogen contained in a measurement gas flowing in a flow channel.

### BACKGROUND ART

As shown in the patent document 1, a conventional hydrogen concentration measuring instrument comprises a thermopile formed on a semiconductor substrate and a catalytic layer formed by a carbon cluster supporting an oxidation catalyst on a thermosensitive part of the thermopile, and measures a hydrogen concentration by detecting an oxidative reaction heat generated by reacting of the hydrogen gas with an oxidation catalyst of the catalytic layer.

Since the conventional hydrogen concentration measuring instrument is susceptible to a temperature, as shown in the patent document 2, an arrangement is conceived that a hydrogen concentration measuring instrument having the thermosensitive part supporting the oxidation catalyst and the thermosensitive part supporting no oxidation catalyst are arranged in parallel and a difference between detected signals of two temperature measuring elements is obtained in order to cancel the temperature (ambient temperature) of a block body where the temperature measuring element is formed.

### PRIOR ART DOCUMENT

### Patent Document

Patent document 1: Japan Patent Laid-open Number 2006-071362
Patent document 2: Japan Patent laid-open Number 2008-241554

### DISCLOSURE OF THE INVENTION

### Problems to be Solved by the Invention

Since the measurement error still occurs even though the temperature influence is cancelled by the use of the above-mentioned method, the inventor of this invention made a keen examination about the cause of the measurement error from various viewpoints. As a result, the inventor has found that the measurement error of the hydrogen concentration obtained by the temperature measurement element such as the thermopile is generated by not only the influence of the ambient temperature but also the concentration of oxygen contained in the measurement gas, namely, it is difficult to obtain a highly reliable measurement result just by conducting a correction using the ambient temperature.

Then a main object of this invention is to obtain a highly reliable measurement result by correcting the hydrogen concentration by the use of the concentration of oxygen contained in the measurement gas.

### Means to Solve the Problems

More specifically, the hydrogen concentration measuring instrument in accordance with this invention is characterized by comprising a hydrogen concentration measuring part that measures a concentration of hydrogen contained in a measurement gas flowing in a flow channel, an oxygen concentration measuring unit that measures a concentration of oxygen contained in the measurement gas, and a concentration correcting unit that corrects the concentration of hydrogen obtained by the hydrogen concentration measuring part by the use of the concentration of oxygen obtained by the oxygen concentration measuring unit.

In accordance with this arrangement, since the hydrogen concentration is corrected by the use of the concentration of oxygen contained in the measurement gas, it is possible to correct an influence of the oxygen concentration on the hydrogen concentration so that the concentration of hydrogen contained in the measurement gas can be measured at a high accuracy. As a result, it is possible to obtain a highly reliable measurement result.

It is preferable to comprise a casing that houses the hydrogen concentration measuring part, an inlet port that is arranged in the casing and connected to an external piping and that introduces the measurement gas into inside of the casing, and a outlet port that is arranged in the casing and connected to an external piping and that discharges the measurement gas from the inside of the casing. With this arrangement, there is no need of forming an opening part for the existing external piping to insert the sensor and the hydrogen concentration measuring part can be mounted inline easily and simply also both from the structural aspect and from the assembling aspect just by directly connecting the external piping to the inlet port and the outlet port.

In addition, in order to reduce a measurement error as much as possible by conducting a humidity correction on a combustible gas concentration obtained by a gas sensor without arranging a humidity sensor in a sensor block where the gas sensor is arranged, the gas concentration measuring instrument is a gas concentration measuring instrument that measures a concentration of a combustible gas contained in the measurement gas by detecting a heat release value of the measurement gas, and is characterized by comprising a sensor block to which or from which the measurement gas is supplied or discharged through an external piping, a sensing part that is arranged in the sensor block and that outputs a detected signal in accordance with a concentration of the combustible gas contained in the measurement gas, a humidity measuring unit that is arranged in the external piping and that measures a humidity of the measurement gas flowing in the external piping, a first temperature measuring unit that is arranged in the external piping and that measures a temperature of the measurement gas flowing in the external piping, a second temperature measuring unit that is arranged in the sensor block and that measures a temperature of inside of the sensor block, a humidity calculating part that receives output signals from the first temperature measuring unit, the second temperature measuring unit and the humidity measuring unit and that calculates the humidity in the sensor block, and a concentration correcting unit that corrects the combustible gas concentration calculated from the detected signal from the sensing part by the use of the humidity obtained by the humidity calculating part.

In accordance with this arrangement, since it is possible to calculate the relative humidity in the sensor block by means of the humidity measuring unit and the first temperature measuring unit arranged in the external piping and the second temperature measuring unit arranged in the sensor block, there is no need of arranging the humidity sensor in the sensor block. As a result, it is possible to reduce the measurement error as much as possible by conducting the humidity correction on the combustible gas concentration without providing a humidity sensor of a high temperature specification in the sensor block.

In order to make the effect of this invention further more remarkable and to measure the hydrogen concentration as the combustible gas concentration preferably as well, it is preferable that the sensing part is a thermopile whose thermosensitive part supports the oxidation catalyst that generates the oxidation reaction heat at a time of making contact with the combustible gas.

In addition, a conventional gas concentration measuring instrument comprises a thermopile formed on a semiconductor substrate and a catalytic layer formed by a carbon cluster supporting an oxidation catalyst on a thermosensitive part of the thermopile, and measures a concentration of a combustible gas by detecting an oxidative reaction heat generated by reaction of the combustible gas with the oxidation catalyst of the catalyst layer.

Then the thermopile outputs a temperature change of the thermosensitive part as a voltage change, and in case that the ambient temperature of the block body where the thermopile is formed changes, a drift (an offset voltage) is generated in accordance with the temperature change of the thermosensitive part irrespective of an effect of the measurement gas. As a result, the measured value fluctuates largely due to an influence from the ambient temperature so that there is a problem that a measurement error occurs.

Under this situation, in order to cancel the drift due to the influence from the ambient temperature, an arrangement is conceived that the thermosensitive part supporting the oxidation catalyst and the thermosensitive part supporting no oxidation catalyst are arranged in parallel so as to obtain a difference between the detected signals of two temperature measuring elements.

However, although the hydrogen concentration is corrected by the use of the ambient temperature, since it is not corrected by the temperature of the measurement gas itself, the temperature of the thermosensitive part changes due to the temperature of the measurement gas itself, resulting in occurring the measurement error. Even though it is considered that the temperature of the block body changes due to an influence from the temperature of the measurement gas, the temperature of the block body is different from the temperature of the measurement gas itself so that a correction error occurs and there is also a problem that it is not possible to conduct correction in real time.

In addition, as mentioned above, with the arrangement comprising the thermopile supporting the oxidation catalyst and the thermopile without supporting the oxidation catalyst, in addition to a problem that a number of components increases so that a manufacturing cost increases, there is a restriction to downsize the sensor because thermopiles are arranged in parallel.

In order to solve these problems, a gas concentration measuring instrument that measures a concentration of a combustible gas contained in the measurement gas by detecting a heat release value of the measurement gas is characterized by comprising a thermopile whose thermosensitive part supports an oxidation catalyst that produces oxidative reaction heat due to contact with a combustible gas, a gas temperature measuring part that is arranged to contact the combustible gas and that detects the temperature of the combustible gas and a concentration measuring part that corrects the concentration obtained by the use of the thermopile by using the temperature obtained by the gas temperature measuring part.

In accordance with this arrangement, since the gas concentration measuring instrument comprises a single thermopile supporting the oxidation catalyst, it is possible to simplify a configuration of the gas concentration measuring instrument and to downsize the device and also reduce the cost. In addition, since the gas temperature sensor is arranged to contact the measurement gas, and the temperature of the measurement gas is directly measured and the hydrogen concentration is corrected by the use of the temperature of the measurement gas, it is possible to correct the hydrogen concentration obtained by the thermopile with high accuracy. Furthermore, since the thermopile supports the oxidation catalyst, even though a case of measuring the combustible gas of low concentration, it is possible to detect the oxidative reaction heat generated due to the oxidative reaction of the combustible gas and the oxidation catalyst by means of the thermopile so that the measurement accuracy can be improved.

### Effect of the Invention

In accordance with this invention of the above-mentioned arrangement, it is possible to measure the concentration of hydrogen by correcting the concentration of hydrogen by the use of the concentration of oxygen contained in the measurement gas.

### BRIEF DESCRIPTION OF THE DRAWINGS

FIG. 1 is an overall configuration diagram of a gas concentration measuring instrument in accordance with one embodiment of this invention.

FIG. 2 is a pattern cross sectional view showing the configuration of the gas concentration measuring instrument of this embodiment.

FIG. 3 is a pattern cross sectional view showing a configuration of a sensing part of this embodiment.

FIG. 4 is a view showing a relationship between a hydrogen concentration and humidity and a relationship between a hydrogen concentration and a temperature.

FIG. 5 is a view showing a relationship between a hydrogen concentration and an oxygen concentration.

### BEST MODES OF EMBODYING THE INVENTION

One embodiment of a gas concentration measuring instrument in accordance with this invention will be explained with reference to drawings.

<Device Configuration>

The hydrogen concentration measuring instrument 100 in accordance with this embodiment is arranged between an external piping Z1 and an external piping Z2 where a measurement gas flows and of an in-line type that measures a concentration of hydrogen contained in the measurement gas.

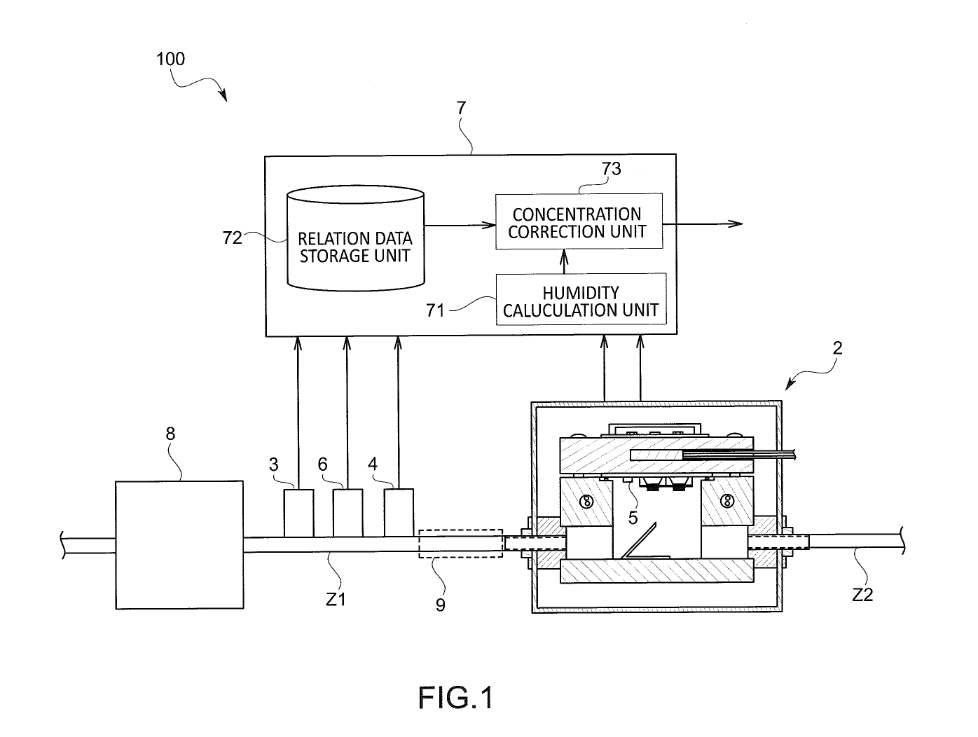

Concretely, as shown in FIG. 1, the hydrogen concentration measuring instrument 100 comprises a hydrogen sensing unit 2 (a hydrogen concentration measuring part) that measures a concentration of hydrogen contained in the measurement gas, an oxygen concentration measuring unit 3 that measures a concentration of oxygen contained in the measurement gas, a first temperature measuring unit 4 that measures a temperature of the measurement gas, a second temperature measuring unit 5 that measures a temperature of the measurement gas, a humidity measuring unit 6 that measures a relative humidity of the measurement gas, and a arithmetic control unit 7 that calculates a concentration of hydrogen by receiving output signals from the above-mentioned measuring parts 2-6. The external piping Z1 at an upstream side is provided with a drain separator 8 that reduces a relative humidity in the measurement gas flowing in the external piping Z1 to, for example, 80% or less. In addition, at a downstream side of the drain separator 8 in the external piping Z1 arranged is a piping heater 9 that uses a resistance heating element to heat the measurement gas flowing in the external piping Z1 at a temperature of a sensor block 22, to be described later.

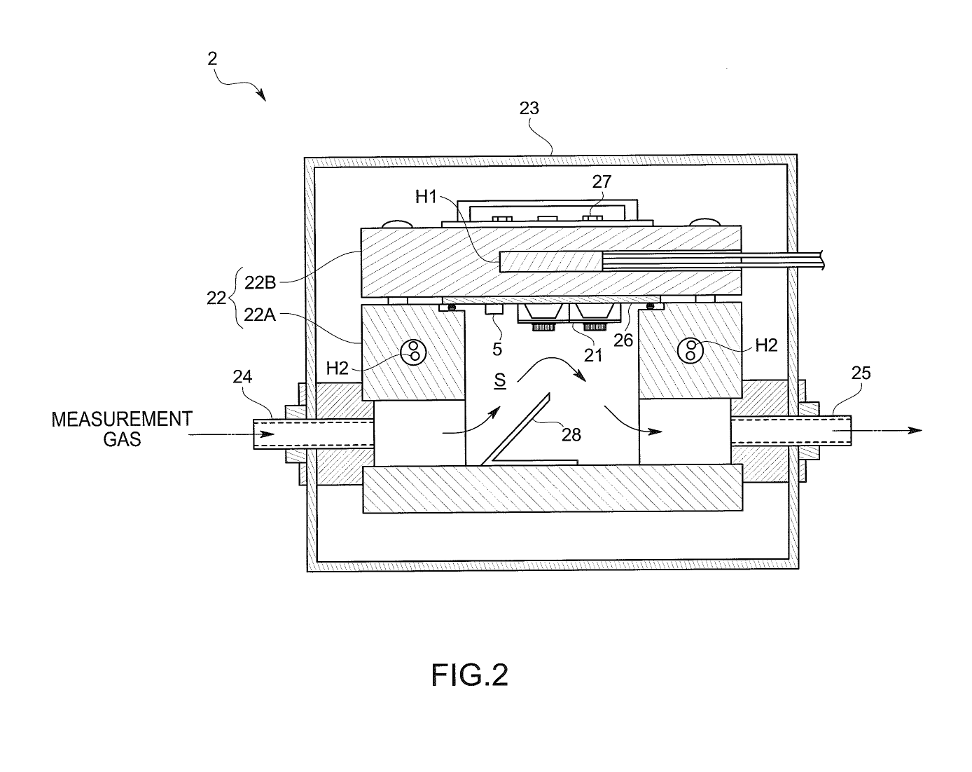

The hydrogen sensing unit 2 comprises, as shown in FIG. 2, a sensing part 21 that conducts catalytic combustion on hydrogen contained in the measurement gas and detects its heat release value, a sensor block 22 that supports the sensing part 21, a casing 23 that houses the sensor block 22 and that has a thermal insulation function and an electromagnetic shield function, an inlet port 24 that is arranged in the casing 23 and that is connected to the external piping Z1, and a outlet port 25 that is arranged in the casing 23 and that is connected to the external piping Z2.

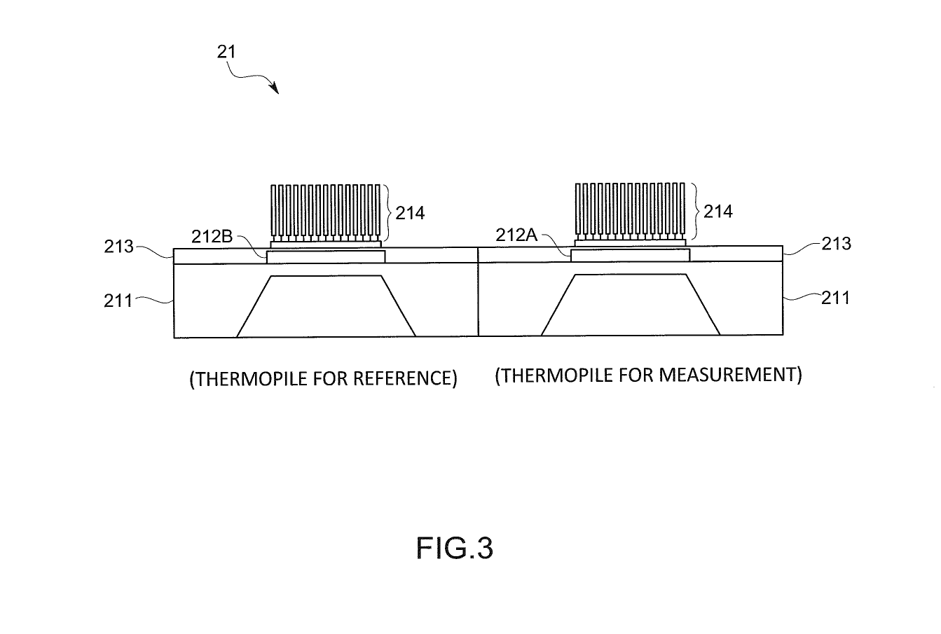

The sensing part 21 is arranged on a base substrate 26 as being a heat-resistant semiconductor substrate. A concrete configuration of the sensing part 21 is of a differential type and comprises, as shown in FIG. 3, a silicon substrate 211 as being the heat-resistant semiconductor substrate whose one surface (a back surface) of a center part formed is a concave part by etching, thermopiles (a thermopile for measurement 212A and a thermopile for reference 212B) formed on the other surface (a front surface) of the silicon substrate 211, an insulation film 213 formed on a whole area of the surface of the silicon substrate 211 including a surface of the thermopile 212A and a surface of the thermopile 212B, and a catalytic layer 214 formed on a hot junction part as being a thermosensitive part of the thermopile 212A, 212B of the insulation layer 213.

The thermopile 212A, 212B is formed by joining dissimilar metals such as, for example, polysilicon and aluminum, and generates and outputs a thermal electromotive force according to a heating value due to the Seebeck effect. The thermal electromotive force (an output signal) output by the thermopile 212A, 212B is amplified by a preamplifier 27 arranged on an upper block body 22B, to be described later, and then the amplified thermal electromotive force is output to a arithmetic control unit 7.

The catalytic layer 214 of the thermopile 212A is formed with multiple pieces of carbon clusters, more specifically, carbon nano tubes (CNT) that preliminarily support particles of precious metal catalyst such as platinum (Pt) or palladium (Pd) as being an example of an oxidation catalyst that produces oxidation reaction heat due to contact with hydrogen, arranged mutually in parallel and generally perpendicular to the insulation film 213. In addition, the catalytic layer 214 of the thermopile 212B is formed with multiple pieces of carbon clusters supporting no oxidation catalyst, more concretely, carbon nano tubes (CNT) arranged mutually in parallel and generally perpendicular to the insulation film 213.

The sensor block 22 is made of a non-corrosive material such as, for example, a metal or the like, and comprises a bottom block body 22A having a void S opening on an upper surface and side surfaces facing each other, and a top block body 22B that blocks an opening of the void S opening on the upper surface of the bottom block body 22A. A temperature measuring device H1 and a heater H2 are buried in the top block body 22B and the bottom block body 22A in order to adjust a temperature of each block body 22A, 22B.

The base substrate 26 is sandwiched between the bottom block body 22A and the top block body 22B by screwing multiple setscrews from the upper surface side of the top block body 22B to the lower block body 22A side in a state that the opening on the upper surface of the bottom block body 22A is blocked by the base substrate 26 so as to locate the sensing part 21 in the void S. At this time, it is so arranged that inside of the void S is kept airtight by arranging a seal member such as an O-ring around an entire circumference of a part where the bottom block body 22A makes contact with a peripheral part of the base substrate 26. With this arrangement, a flow channel where the measurement gas flows is formed inside of the sensor block 22, and the sensing part 21 (the thermopile 212A, 212B) is arranged in the flow channel. The reference code 28 in FIG. 2 is a guide plate that guides the measurement gas from the inlet port 24 toward the sensing part 21 (the catalytic layer 214) in order to make the measurement gas flowing into the sensor block 22 contact with the catalytic layer 214.

The inlet port 24 arranged for the casing 23 is in communication with an upstream side of the flow channel formed by the sensor block 22 and the external piping Z1 is connected to the inlet port 24. Meanwhile, the outlet port 25 arranged for the casing 23 is in communication with a downstream side of the flow channel and the external piping Z2 is connected to the outlet port 25.

The oxygen concentration measuring unit 3 is arranged by being inserted into an upstream side of the pipe heater 9 in the external piping Z1 locating at the upstream side of the hydrogen sensing unit 2. For example, a zirconia oxygen sensor can be used as the oxygen concentration measuring unit 3. Then an output signal from the oxygen concentration measuring unit 3 is output to the arithmetic control unit 7. A position where the oxygen concentration measuring unit 3 is placed is not limited to the external piping Z1, and may be arranged in the external piping Z2 or the hydrogen sensing unit 2 (concretely, the sensor block 22). In case that the oxygen concentration measuring unit 3 is arranged inside of the sensor block 22, since a temperature of the sensor block 22 is considered to be raised to 80° C.-125° C., the oxygen sensor has to be a high temperature oxygen sensor, which might lead to a cost increase.

The first temperature measuring unit 4 is arranged by being inserted into an upstream side of the pipe heater 9 in the external piping Z1 locating at the upstream side of the hydrogen sensing unit 2 so as to make contact with the measuring object gas flowing in the external piping Z1. In addition, the second temperature measuring unit 5 is arranged in the flow channel formed inside of the sensor block 22 so as to make contact with the measuring object gas flowing in the flow channel. The second temperature measuring unit 5 of this embodiment is arranged to be adjacent to the sensing part 21 on the base substrate 26. For example, a temperature sensor using a platinum resistance thermometer bulb, a thermister or a thermocouple may be used as the first temperature measuring unit 4 and the second temperature measuring unit 5. An output signal from the first temperature measuring unit 4 and an output signal from the second temperature measuring unit 5 are output to the arithmetic control unit 7. A position where the first temperature measuring unit 4 is placed is not limited to the external piping Z1 locating at the upstream side, and may be arranged on the external piping Z2 locating at the downstream side.

The humidity measuring unit 6 is arranged by being inserted into an upstream side of the pipe heater 9 in the external piping Z1 locating at the upstream side of the hydrogen sensing unit 2. A humidity sensor such as, for example, a polymer membrane humidity sensor or a ceramic humidity sensor can be used as the humidity measuring unit 6. An output signal from the humidity measuring unit 6 is output to the arithmetic control unit 7. A position where the humidity measuring unit 6 is placed is not limited to the external piping Z1, and may be the humidity sensor unit 2 (concretely the sensor block 22).

The arithmetic control unit 7 receives the output signal from the hydrogen sensing unit 2, the oxygen concentration measuring unit 3, the first temperature measuring unit 4, the second temperature measuring unit 5 and the humidity measuring unit 6 respectively, and calculates the hydrogen concentration, the oxygen concentration, the relative humidity, and the temperature are calculated based on each output signal and the hydrogen concentration is corrected by the use of the oxygen concentration, the humidity and the temperature. The arithmetic control unit 7 receives the output signal from the second temperature measuring unit 5 arranged inside of the sensor block 22 and controls the heater H2 based on the temperature obtained by the temperature measurement device H1 and also controls the pipe heater 9 so that the temperature of the sensor block 22 becomes at a constant value. In addition, the arithmetic control unit 7 calculates the hydrogen concentration by the use of the difference between an output signal (an electromotive force) of the thermopile 212A for measurement of the hydrogen sensing unit 2 and an output signal (an electromotive force) of the thermopile 212B for reference of the hydrogen sensing unit 2.

Concretely, the arithmetic control unit 7 is a dedicated or general purpose computer comprising a CPU, a memory, an input/output interface, an AD convertor or the like, and produces functions as a humidity calculating part 71, a relation data storage unit 72, a concentration correcting unit 73 or the like by operating the CPU and the peripheral devices based on predetermined programs stored in a predetermined area of the memory.

The humidity calculating part 71 receives the output signals from the first temperature measuring unit 4, the second temperature measuring unit 5 and the humidity measuring unit 6 and calculates the relative humidity in the sensor block 22 by the use of the Tetens' formula. Concretely, the humidity calculating part 71 calculates the above-mentioned relative humidity by the following equation.

$${RH}_{t} = \frac{{m}_{w}}{{P}_{t}} \times 100 \qquad ( Equation 1 )$$

wHere, RHₜ (%) is the relative humidity at t° C., t° C. is the temperature of the measurement gas in the external piping Z1, m_{w} is the amount of water vapor contained in the measurement gas at t° C., and Pₜ is the amount of saturated water vapor at t° C.

$${RH}_{T} = \frac{{M}_{w}}{{P}_{T}} \times 100 \qquad ( Equation 2 )$$

where, RH_{T} (%) is the amount of saturated water vapor at T° C., T° C. is the temperature of the measurement gas in the sensor block 22, M_{W} is the amount of water vapor contained in the measurement gas at T° C., and P_{T} is the amount of saturated water vapor at T° C.

Since the measurement gas is dehumidified by the drain separator 8 arranged in the upstream of the external piping Z1 so that the amount of the water vapor m_{W} contained in the measurement gas in the external piping Z1 and the amount of the water vapor M_{W} contained in the measurement gas in the sensor block 22 do not change substantially, the following equation 3 is satisfied.

$${RH}_{T} = {RH}_{T} \times \frac{{P}_{t}}{{P}_{T}} \qquad ( Equation 3 )$$

If the Tetens' formula is used, the relative humidity RH_{T} in the sensor block 22 is expressed by the following equation 4

$${RH}_{T} = {RH}_{t} \times {10}^{7.5 ( \frac{t}{t + 237.3} - \frac{T}{T + 237.3} )} \qquad ( Equation 4 )$$

The relative humidity RH_{T} can be calculated from the relative humidity RHₜ (%) of the measurement gas in the external piping Z1, the temperature t (° C.) of the measurement gas in the external piping Z1, and the temperature T (° C.) of the measurement gas in the sensor block 22.

The relation data storage unit 72 stores a humidity relation data showing a relationship (relationship of hydrogen concentration−humidity) between the hydrogen concentration output by the hydrogen sensing unit 2 and the humidity of the measurement gas, a temperature relation data showing a relationship (relationship of hydrogen concentration−temperature) between the hydrogen concentration and the temperature of the measurement gas, and an oxygen concentration relation data showing a relationship (relationship of hydrogen concentration−oxygen concentration) between the hydrogen concentration and the oxygen concentration contained in the measurement gas. These data are preliminarily input by a user.

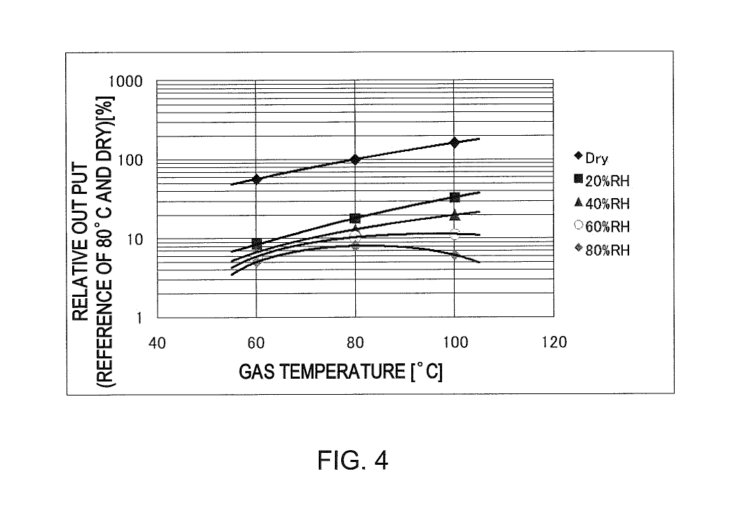

Regarding the humidity relation data and the temperature relation data, as shown in FIG. 4, a data showing a relationship between the temperature of the measurement gas and the relative output (%) to a reference of 80° C. and dry is stored. The relative output to the 80° C. and dry reference is a ratio in a case that the hydrogen concentration obtained by the thermopile 212A is set 100 for the measurement gas in a state that the temperature is 80° C. and the relative humidity is 0%, and is preliminarily obtained by an experiment.

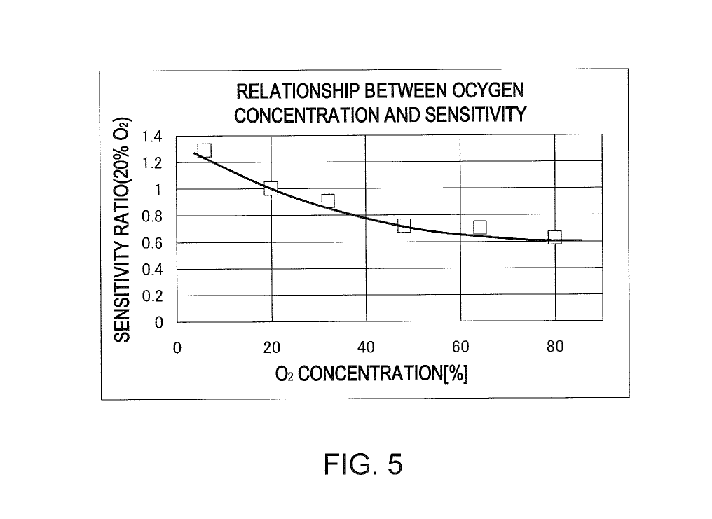

In addition, regarding the oxygen concentration relation data, as shown in FIG. 5, a data showing a sensitivity characteristics (a sensitivity ratio) of the thermopile 212A for each oxygen concentration is stored. The sensitivity characteristics is a ratio of the measured value of the hydrogen concentration in the measurement gas whose oxygen concentration is other than 20% to the measured value of the hydrogen concentration in the measurement gas whose oxygen concentration is 20%. In other words, the sensitivity characteristics is a data showing an influence of the oxygen concentration of the measurement gas on the measured value of the hydrogen concentration.

The concentration correcting unit 73 corrects the hydrogen concentration obtained by the thermopile 212A based on the oxygen concentration, the relative humidity in the sensor block 22 obtained by the humidity calculating part 71, and the temperature of the measurement gas in the sensor block 22 by the use of the above-mentioned relationship of hydrogen concentration−humidity, the relationship of hydrogen concentration−temperature and the relationship of hydrogen concentration−oxygen concentration. The concentration correcting unit 73 displays the hydrogen concentration after correction on a display, not shown in drawings.

Concretely, in case that the oxygen concentration of the measurement gas is 50%, since the measurement sensitivity drops by about 70% from the reference of the measurement gas whose oxygen concentration is 20%, the hydrogen concentration is corrected by being multiplied by about 10/7.

In addition, for example, in case that the temperature of the gas is 80° C. and the relative humidity of the gas is 20%, since the relative output to the reference of 80° C. and dry becomes about 18% from the relationship shown in FIG. 4, the hydrogen concentration is corrected by being multiplied by about 100/18. For example, in case that the temperature of the gas is 60° C. and the relative humidity of the gas is 40%, since the relative output to the reference of 80° C. and dry becomes about 7% from the relationship shown in FIG. 4, the hydrogen concentration is corrected by being multiplied by about 100/7. Furthermore, in case that the humidity is not shown in FIG. 4, the relative output is obtained by interpolating the relative humidity curve shown in FIG. 4 and the hydrogen concentration is corrected.

With the above-mentioned procedure, a reduced value of the hydrogen concentration at a time of the reference of 80° C. and dry and the oxygen concentration of 20% is calculated. The reference for correction is not limited to the reference of 80° C. and dry and the oxygen concentration of 20%. In case that the other reference is used, the relationship using the other reference is preliminarily obtained by means of the experiment and the relation data showing the relationship is stored in the relation data storage unit 72.

### Effect of this Embodiment

In accordance with the gas concentration measuring instrument 100 in accordance with this embodiment having the above-mentioned arrangement, since the hydrogen concentration is corrected by the use of the concentration of oxygen contained in the measurement gas, it is possible to correct an influence of the oxygen concentration on the hydrogen concentration so that the concentration of hydrogen contained in the measurement gas can be measured with high accuracy. As a result, it is possible to obtain a highly reliable measurement result.

### Other Modified Embodiment

The present claimed invention is not limited to the above-mentioned embodiment.

For example, from a view point of reducing a number of components, the first temperature measuring unit and the humidity measuring unit may be composed by a temperature humidity sensor.

In addition, the first temperature measuring unit and the second temperature measuring unit are arranged in the above-mentioned embodiment, however, one temperature measuring part is arranged inside of the hydrogen sensing unit and only the temperature of the measurement gas flowing into the hydrogen sensing unit may be measured. In this case, the humidity sensor also is arranged inside of the hydrogen sensing unit. At this time, the humidity calculating part 71 is not necessary.

Furthermore, in order to improve the correction accuracy, the oxygen concentration obtained by the oxygen concentration measuring unit may be corrected. Concretely, the pressure sensor to measure the pressure of the measurement gas is arranged near the oxygen concentration measuring unit and the oxygen concentration is corrected by the use of the output value from the pressure sensor. It is possible to calculate the more accurate hydrogen concentration by correcting the hydrogen concentration by the use of the corrected oxygen concentration.

Furthermore, the hydrogen concentration measuring part of the above-mentioned embodiment is the contact combustion sensor using the thermopile, however, it may be the contact combustion sensor using other temperature measuring element or may be a gas thermal conductivity sensor or a hot wire semiconductor sensor.

As a reason why the hydrogen concentration measuring part is influenced by the oxygen concentration represented is that the oxygen is related to an exothermal reaction or an endothermal reaction in one way or another such that, for example, the exothermic heat due to oxidization of hydrogen is utilized for measurement, or the exothermal reaction or the endothermal reaction due to the measurement component is disturbed by an existence of oxygen.

In addition, the effect is especially remarkable for the gas concentration measuring instrument of this invention in case that the hydrogen concentration is measured under a condition wherein the oxygen exists in high concentrations. As a result, it is preferable that the gas concentration measuring instrument of this invention is arranged on the oxygen supply line of a fuel cell system so as to detect the hydrogen leak in the oxygen supply line.

Furthermore, a part or all of the above-mentioned embodiment or the modified embodiment may be appropriately combined, and it is a matter of course that the present claimed invention is not limited to the above-mentioned embodiment and may be variously modified without departing from a spirit of the invention.

### EXPLANATION of CODE

100 . . . gas concentration measuring instrument
Z1, Z2 . . . external piping
2 . . . hydrogen sensing unit (hydrogen concentration measuring part)
212A, 212B . . . thermopile
23 . . . casing
24 . . . inlet port
25 . . . outlet port
3 . . . oxygen concentration measuring unit
4 . . . first temperature measuring unit
5 . . . second temperature measuring unit
6 . . . humidity measuring unit
7 . . . arithmetic control unit
72 . . . relation data storage unit
73 . . . concentration correcting unit

1. A hydrogen concentration measuring instrument comprising
a hydrogen concentration measuring part that measures a concentration of hydrogen contained in a measurement gas flowing in a flow channel,
an oxygen concentration measuring unit that measures a concentration of oxygen contained in the measurement gas, and
a concentration correcting unit that corrects the concentration of hydrogen obtained by the hydrogen concentration measuring part by the use of the concentration of oxygen obtained by the oxygen concentration measuring unit.

2. The hydrogen concentration measuring instrument described in claim 1, wherein comprising
a casing that houses the hydrogen concentration measuring part,
an inlet port that is arranged in the casing and connected to an external piping and that introduces the measurement gas into inside of the casing, and
a outlet port that is arranged in the casing and connected to an external piping and that discharges the measurement gas from the inside of the casing.
